(19) United States
(12) Patent Application Publication
(10) Pub. No.: US 2026/0140382 A1
(43) Pub. Date: May 21, 2026

(54) NEAR EYE DISPLAY DEVICE

(71) Applicant: Coretronic Corporation, Hsin-Chu (TW)

(72) Inventors: Wan-Lin Li, Hsin-Chu (TW); Yi-Chien Lo, Hsin-Chu (TW); Hung-Pin Chen, Hsin-Chu (TW); Wen-Chun Wang, Hsin-Chu (TW)

(73) Assignee: Coretronic Corporation, Hsin-Chu (TW)

(21) Appl. No.: 19/370,770

(22) Filed: Oct. 28, 2025

(30) Foreign Application Priority Data
Nov. 21, 2024 (CN) 202422841776.8

(51) Int. Cl. G02B 27/01; G02B 6/34; G02B 27/00

(52) U.S. Cl. CPC G02B 27/0172; G02B 6/34; G02B 27/0081; G02B 2027/0123

(57) ABSTRACT

A near eye display device includes a waveguide, an image generating device, a light input coupling element, a light output coupling element, and a light leakage suppression element. The waveguide has a first surface and a second surface opposite to each other. The first surface also includes a light incident area and a light exit area. The image generating device is adapted to emit an image beam toward the light incident area. The light input coupling element is disposed in the light incident area, and the light output coupling element is disposed in the light exit area. The light leakage suppression element is disposed on the second surface and is disposed opposite to the light exit area.

### CROSS-REFERENCE TO RELATED APPLICATION

This application claims the priority benefit of China application serial no. 202422841776.8, filed on November 21, 2024. The entirety of the above-mentioned patent application is hereby incorporated by reference herein and made a part of this specification.

### BACKGROUND

### Technical Field

The disclosure relates to a display device, and in particular to a near eye display device.

### Description of Related Art

In the application of a near eye display device, such as an augmented reality (AR) device, a mixed reality (MR) device, or smart glasses, coupling gratings are usually configured to refract an image beam o incident on the waveguide into an angle greater than a critical angle, so that the image beam is transmitted to the coupling gratings in the light waveguide by total internal reflection (TIR) to generate exit pupil expansion(EPE), and the image beam is transmitted to the eyes of a user.

However, during the process of irradiating the image beam onto the coupling gratings, the image beam may be easily transmitted toward unexpected directions due to multi-order diffraction to become leakage light or stray light. The leakage light may cause a non-user located directly opposite to the user to clearly see the same screen. In addition to violating the privacy of the user, the near eye display device may also easily affect the non-user when being used, reducing the product value of the near eye display device and the experience.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

An embodiment of the disclosure provides a near eye display device, which includes a waveguide, an image generating device, a light input coupling element, a light output coupling element, and a light leakage suppression element. The waveguide has a first surface and a second surface opposite to each other. The first surface includes a light incident area and a light exit area. The image generating device is adapted to emit an image beam toward the light incident area. The light input coupling element is disposed in the light incident area, and the light output coupling element is disposed in the light exit area. The light leakage suppression element is disposed on the second surface and is disposed opposite to the light exit area.

In order for the features and advantages of the disclosure to be more comprehensible, the following specific embodiments are described in detail in conjunction with the drawings.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a near eye display device according to a first embodiment of the disclosure.

FIG. 2A and FIG. 2B are spectrum diagrams of light leakage suppression of a light leakage suppression element of the embodiment of FIG. 1.

FIG. 3 is a schematic diagram of a near eye display device according to a second embodiment of the disclosure.

FIG. 4 is a schematic diagram of a near eye display device according to a third embodiment of the disclosure.

FIG. 5 is a partial schematic diagram of a near eye display device according to a fourth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

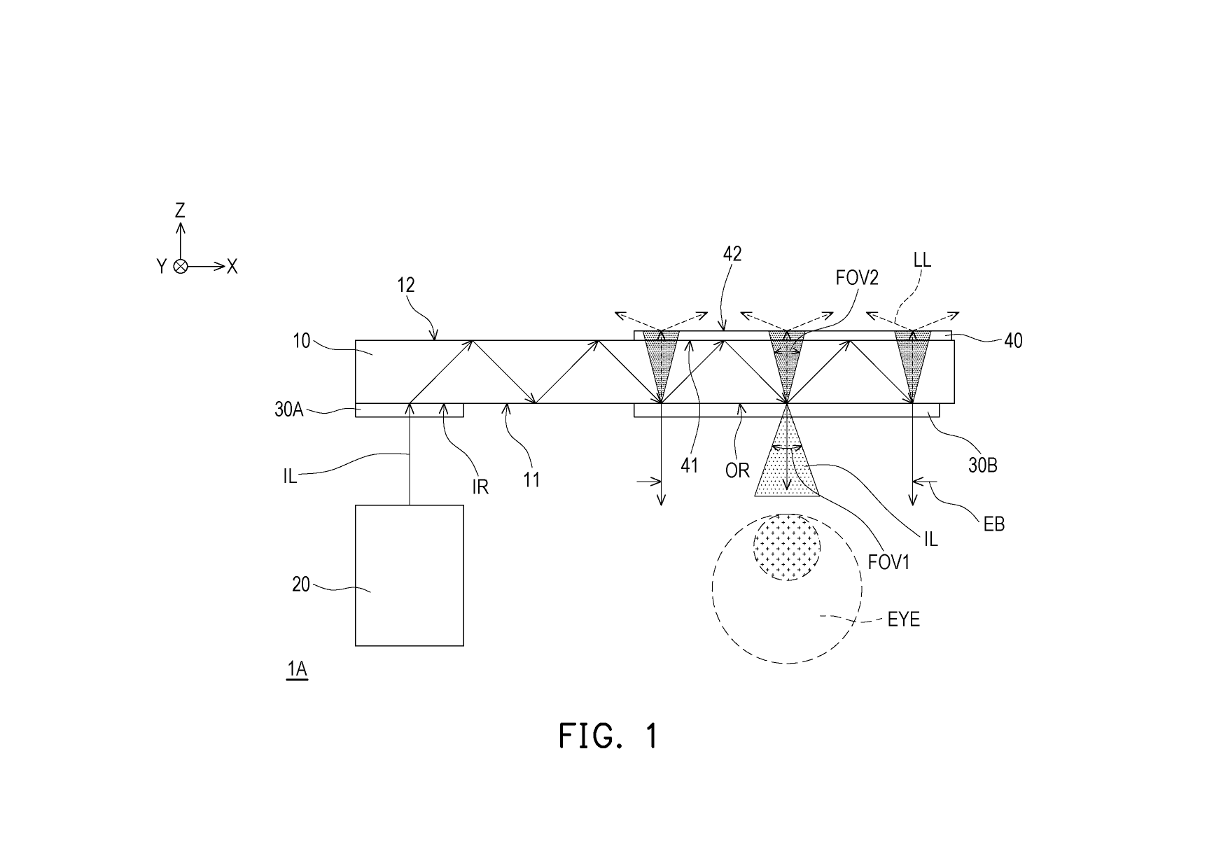

FIG. 1 is a schematic diagram of a near eye display device according to a first embodiment of the disclosure. Please refer to FIG. 1. A near eye display device 1A is configured to provide an image beam IL to an eye EYE of a user. The near eye display device 1A includes a waveguide 10, an image generating device 20, a light input coupling element 30A, a light output coupling element 30B, and a light leakage suppression element 40. The waveguide 10 has a first surface 11 and a second surface 12 opposite to each other. The first surface 11 is located on a side of the waveguide 10 close to the eye EYE. The first surface 11 also includes a light incident area IR and a light exit area OR. The image generating device 20 is adapted to emit the image beam IL toward the light incident area IR. The light input coupling element 30A is disposed in the light incident area IR, and the light output coupling element 30B is disposed in the light exit area OR. The light leakage suppression element 40 is disposed on the second surface 12 and is disposed opposite to the light exit area OR.

The waveguide 10 may be used as the main channel for transmission of the image beam IL. In some embodiments, the material of the waveguide 10 may be glass or a transparent polymer, but the disclosure is not limited thereto. In other embodiments, any material with an appropriate refractive index that can cause the image beam IL to be total internal reflected in the waveguide 10 can be used. In FIG. 1, the first surface 11 and the second surface 12 of the waveguide 10 are shown as planes, but the disclosure is not limited thereto. In other embodiments, the first surface 11 and the second surface 12 may also have corresponding curvatures. From another perspective, the waveguide 10 may also be a curved light waveguide. After the image beam IL is emitted from the waveguide 10, the image beam IL may enter an eye box EB of the eye EYE of the user located on a side of the first surface 11 to be received by the user. The waveguide 10 is also adapted to allow an ambient light transmitted from a side of the second surface 12 to pass through, and allow the eye EYE to see the image beam IL and the ambient light at the same time. In other words, after the image beam IL is emitted from the waveguide 10, an augmented reality image may be formed and viewed by the user.

On the other hand, in some embodiments, the light incident area IR and the light exit area OR of the waveguide 10 may both be arranged along a direction X. In other words, the waveguide 10 may adopt one-dimensional exit pupil expansion (EPE), but the disclosure is not limited thereto.

The image generating device 20 is adapted to emit the image beam IL toward the light incident area IR. For example, the image generating device 20 may include a liquid crystal display, a digital light processing (DLP) projector, a liquid crystal on silicon (LCOS) display, a laser scanning system, or any permutation and combination thereof, but not limited thereto. In some embodiments, the near eye display device 1A may adopt the form of glasses, wherein the image generating device 20 may be fixed on the temples, and the waveguide 10 may be installed in the frame. According to different requirements, the near eye display device 1A may adopt other forms and/or include other elements.

The light input coupling element 30A and the light output coupling element 30B may both be gratings. The types of the gratings may include surface relief gratings (SRG), holographic polymer dispersed liquid crystal (HPDLC) gratings, volume holographic gratings (VHG), or other suitable grating types. The light input coupling element 30A may be configured to couple the image beam IL incident on the waveguide 10 into the waveguide 10, the light output coupling element 30B may be configured to couple the image beam IL emitted from the waveguide 10 into the eye box EB, and the function of the two on the image beam IL is to expand a field of view FOV1 of the image beam IL. The light input coupling element 30A and the light output coupling element 30B may adjust spacing and period of grating arrangement and select materials with appropriate refractive indexes, which may control the diffraction direction of the image beam IL to control coupling efficiency and enhance the pupil expansion effect. In some embodiments, the materials of the light input coupling element 30A and the light output coupling element 30B may be dielectric materials with low absorption and low loss of visible light and near-infrared light, etc., but the disclosure is not limited thereto.

The light leakage suppression element 40 has a first side 41 close to the waveguide 10 and a second side 42 away from the waveguide 10. The light leakage suppression element 40 is configured to diffract a beam incident on the first side 41, so that the traveling direction of the beam changes after leaving the second side 42. In detail, the light leakage suppression element 40 may be at least one of a transmission grating and a reflection grating or may include one or more optical structures or materials. The light leakage suppression element 40 may be directly disposed on the second surface 12, or there may be a spacing (described later) between the first side 41 of the light leakage suppression element 40 and the second surface 12 of the waveguide 10, but the disclosure is not limited thereto.

When the image beam IL is irradiated onto the light output coupling element 30B, a part of the image beam IL undergoes interface reflection or diffraction on the light output coupling element 30B and/or the first surface 11, so that the part of the image beam IL is transmitted toward the direction of the second surface 12, and leaves the second surface 12 toward a direction Z to form a leakage light LL. The leakage light LL may be diffracted (for example, +1^{st}-order to +N^{th}-order diffraction or -1^{st}-order to -N^{th}-order diffraction) again when passing through the light leakage suppression element 40, so that the traveling direction of the leakage light LL originally transmitted toward the direction Z changes. For example, in some embodiments, the light leakage suppression element 40 is adapted to transmit the part of the image beam IL leaving the second surface 12 (which may be defined as the leakage light LL) toward the plane direction of the second surface 12. For example, the light leakage suppression element 40 may be adapted to allow the leakage light LL to deflect toward the direction X, deflect toward a negative direction X, deflect toward a direction Y, or deflect toward a negative direction Y; or adapted to allow the leakage light LL to deflect toward the direction X and the negative direction X at the same time or adapted to allow the leakage light LL to deflect toward the direction Y and the negative direction Y at the same time. In other words, the light incident area IR and the light exit area OR may be arranged along the direction X, and the plane direction of the second surface 12 may be substantially parallel to the direction X or the plane direction of the second surface 12 may be substantially perpendicular to the direction X, but the disclosure is not limited thereto. In this way, the light leakage suppression element 40 may prevent a person opposite to the user (for example, a non-user in the direction Z) from seeing the image beam IL at the same horizontal position. Accordingly, when the user wears the near eye display device 1A, the viewing privacy of the user may be ensured, and the appearance of the near eye display device 1A may be further optimized to enhance product competitiveness.

On the other hand, compared with the conventional technique of tilting the waveguide to deflect the direction of the leakage light LL to prevent the leakage light LL from affecting the non-user, causing an accommodation space for placing the waveguide to be large, which is not conducive to lightweight and miniaturization of the near eye display devices, through the design of disposing the light leakage suppression element 40 on the second surface 12 in the embodiment, the overall thickness of the near eye display device 1A may be reduced. Compared with the conventional technique of filtering out the leakage light LL with a polarizer, the implementation of adopting the light leakage suppression element 40 has a lower absorption rate of ambient light, which also means that the user wearing the near eye display device 1A may more easily receive light rays from the outside, and the interaction with the environment and safety are also improved.

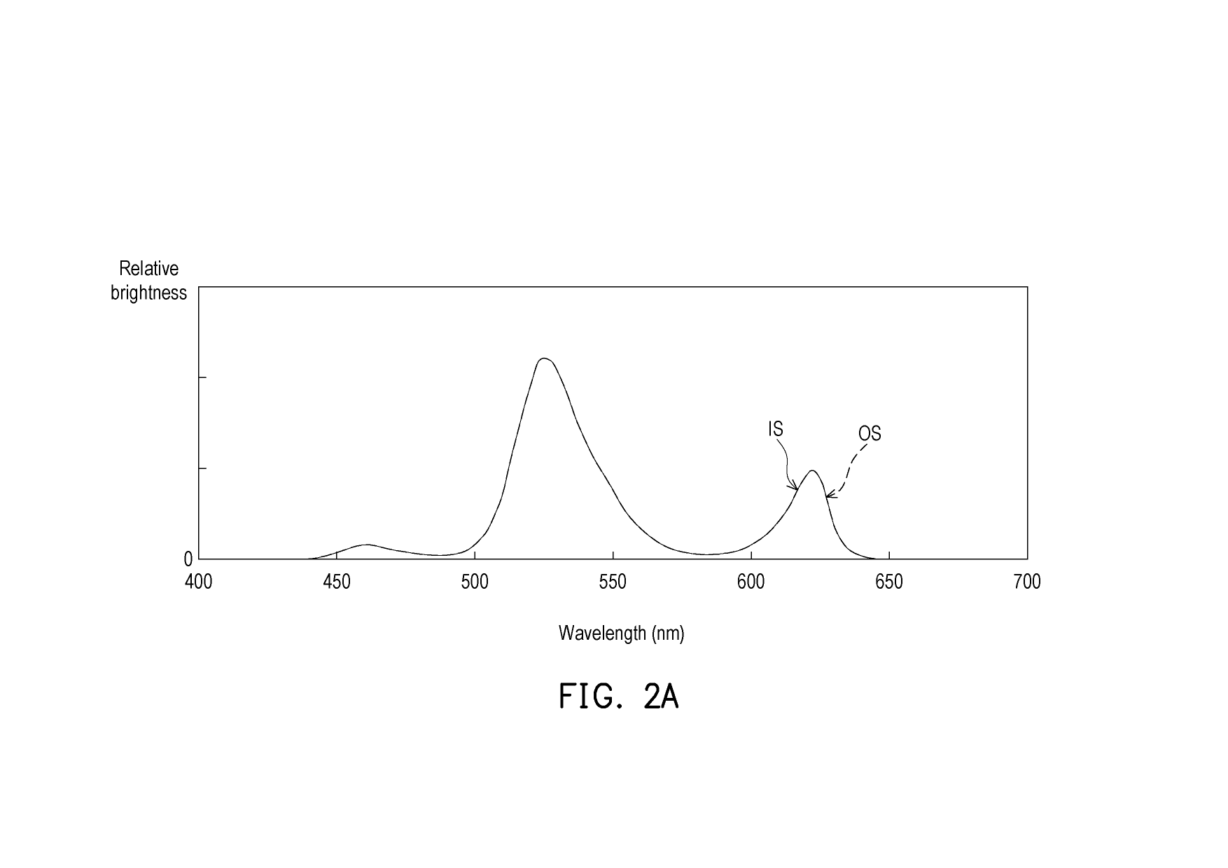

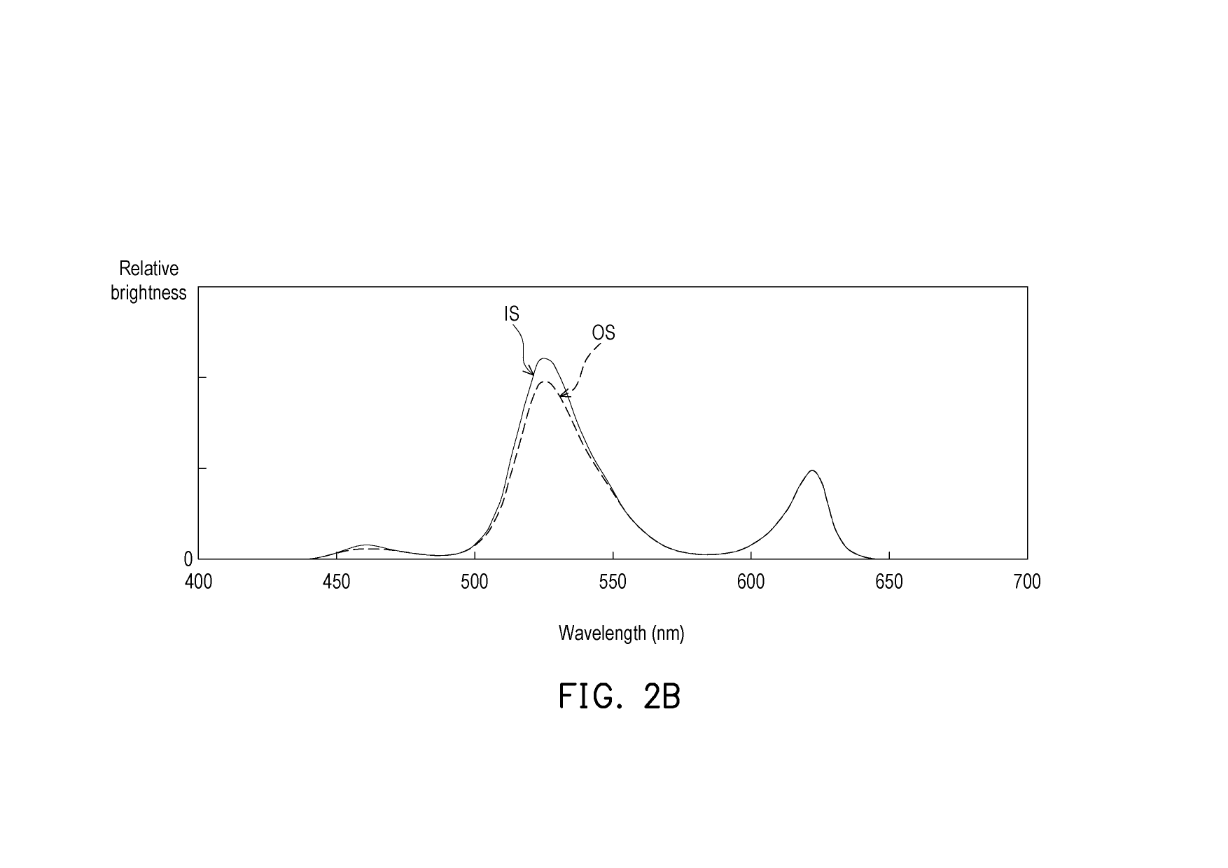

FIG. 2A and FIG. 2B are spectrum diagrams of light leakage suppression of a light leakage suppression element of the embodiment of FIG. 1. Please refer to FIG. 1 to FIG. 2B at the same time. In FIG. 2A, the light leakage suppression element 40 is adapted to allow the leakage light LL toward the direction Z to deflect toward the direction X or the direction Y. Taking an input spectrum IS with the maximum red light flux of 0.2 lumens (lm), the maximum green light flux of 0.75 (lm), and the maximum blue light flux of 0.05 (lm) in the image beam IL as an example, it can be known via simulation experiments that when the image beam IL is transmitted to the first side 41 of the light leakage suppression element 40 at a positive viewing angle (that is, toward the direction Z) and a field of view FOV2 of the leakage light LL is approximately a range of 16 degrees, in the direction X or the direction Y of the second side 42 of the light leakage suppression element 40, a received output spectrum OS almost overlaps with the input spectrum IS. In other words, the actual value of the theoretical efficiency of the light leakage suppression element 40 may be 100%.

On the other hand, in FIG. 2B, the light leakage suppression element 40 is adapted to allow the leakage light LL toward the direction Z to deflect toward the direction Y or the negative direction Y. Taking the input spectrum IS with the maximum red light flux of 0.20 (lm), the maximum green light flux of 0.75 (lm), and the maximum blue light flux of 0.05 (lm) in the image beam IL as an example, it can be known via simulation experiments that when the image beam IL is transmitted to the first side 41 of the light leakage suppression element 40 at a positive viewing angle (that is, toward the direction Z) and the field of view FOV2 of the leakage light LL is approximately a range of 24 degrees, in the direction Y or the negative direction Y of the second side 42 of the light leakage suppression element 40, the maximum red light flux is 0.20 (lm), the maximum green light flux is 0.57 (lm), and the maximum blue light flux is 0.032 (lm) in the received output spectrum OS. In other words, the suppression efficiency of the light leakage suppression element 40 for red light, green light, and blue light may theoretically be approximately 100%, 89%, and 65%. Therefore, when the near eye display device 1A of the embodiment of the disclosure is used, the brightness of the image beam IL received by the non-user in front of the near eye display device 1A may be effectively reduced.

Other embodiments will be enumerated below to describe the disclosure in detail, wherein the same components will be marked with the same numerals, and the description of the same technical content will be omitted. Please refer to the foregoing embodiment for the omitted part, which will not be reiterated below.

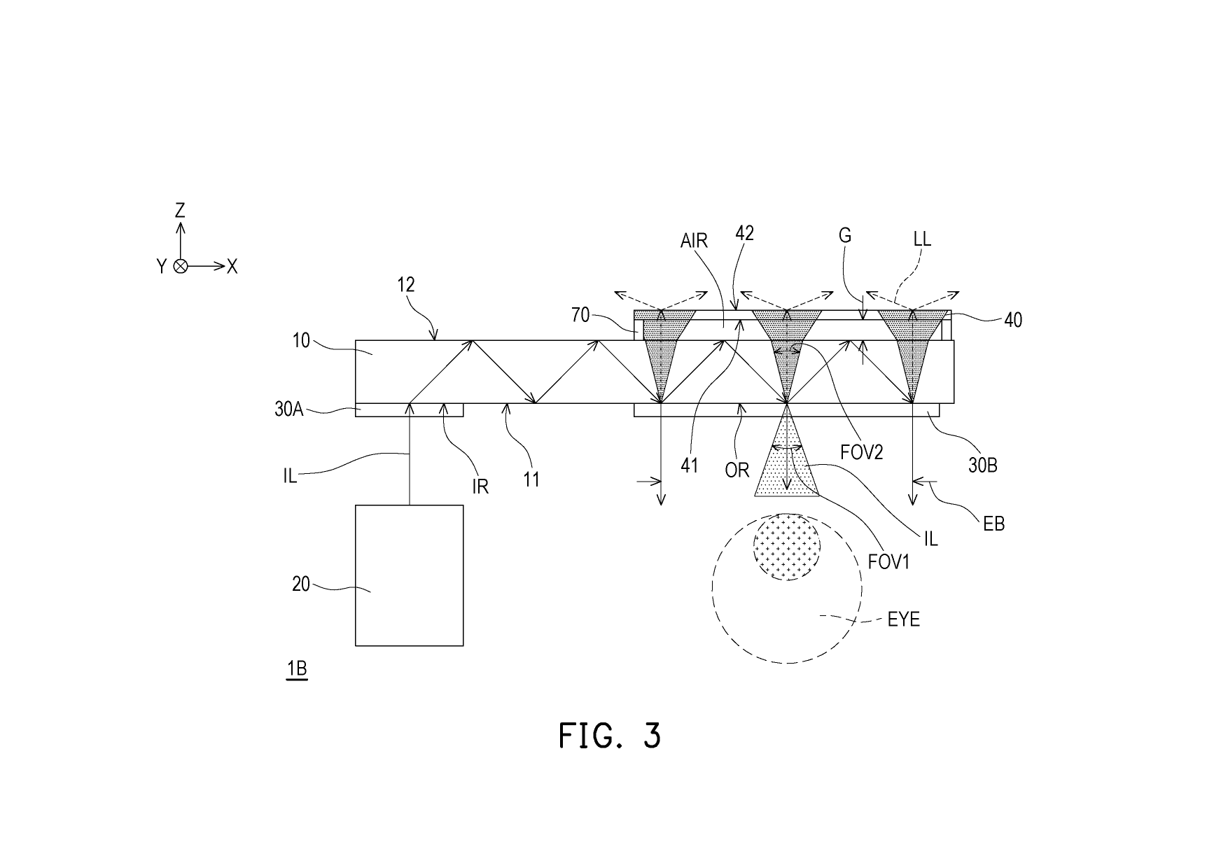

FIG. 3 is a schematic diagram of a near eye display device according to a second embodiment of the disclosure. Please refer to FIG. 3. A near eye display device 1B is similar to the near eye display device 1A of FIG. 1. The main difference is that the near eye display device 1B also includes a spacer 70 for maintaining a spacing G between the light leakage suppression element 40 and the second surface 12 of the waveguide 10 to form an air layer AIR.

In detail, the spacer 70 may include a fixing structure (for example, a screw) or a bonding member (for example, an optical clear adhesive) to prevent the light leakage suppression element 40 from directly contacting the second surface 12. In some embodiments, the spacer 70 may be disposed around the periphery of the light leakage suppression element 40. In other words, the air layer AIR may be a closed air gap to prevent dust or foreign objects from falling in and affecting the viewing experience. In other embodiments, the space (that is, the space where the air layer AIR is located) of the spacing G may also include a refractive index matching medium (not shown). The refractive index range of the refractive index matching medium may be less than the refractive index of the waveguide 10 and greater than the refractive index of the light leakage suppression element 40. The refractive index matching medium may further increase the refraction angle of the leakage light LL transmitted to the light leakage suppression element 40, so that the effect of the light leakage suppression element 40 is enhanced.

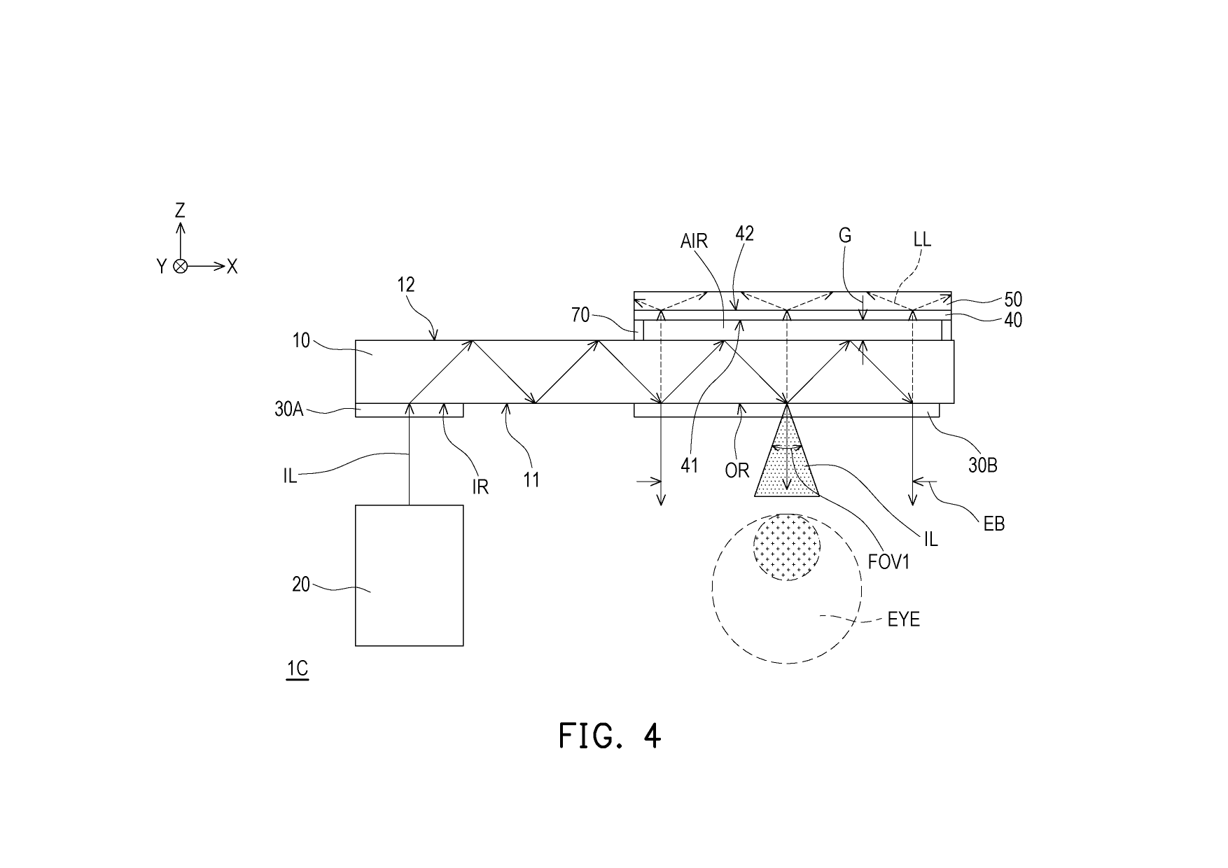

FIG. 4 is a schematic diagram of a near eye display device according to a third embodiment of the disclosure. Please refer to FIG. 4. A near eye display device 1C is similar to the near eye display device 1B of FIG. 3. The main difference is that the near eye display device 1C also includes a light guide layer 50 disposed on the side of the light leakage suppression element 40 relatively away from the waveguide 10, that is, the light guide layer 50 is disposed on the second side 42 of the light leakage suppression element 40. The material of the light guide layer 50 may include a highly light transmissive polymer or glass. When the leakage light LL enters the light guide layer 50 from the second side 42 after being diffracted by the light leakage suppression element 40, the light guide layer 50 may facilitate the leakage light LL to be totally reflected in the light guide layer 50 and transmitted within the light guide layer 50, so that the leakage light LL may be transmitted toward a direction parallel to the direction X or parallel to the direction Y after leaving the light guide layer 50, which may further prevent the leakage light LL from being transmitted to the non-user in the direction Z. In another embodiment not shown, the near eye display device 1C may further omit the spacer 70 and directly dispose the light leakage suppression element 40 with the light guide layer 50 on the second surface 12 of the waveguide 10 to achieve the purpose of thinning of the near eye display device 1C.

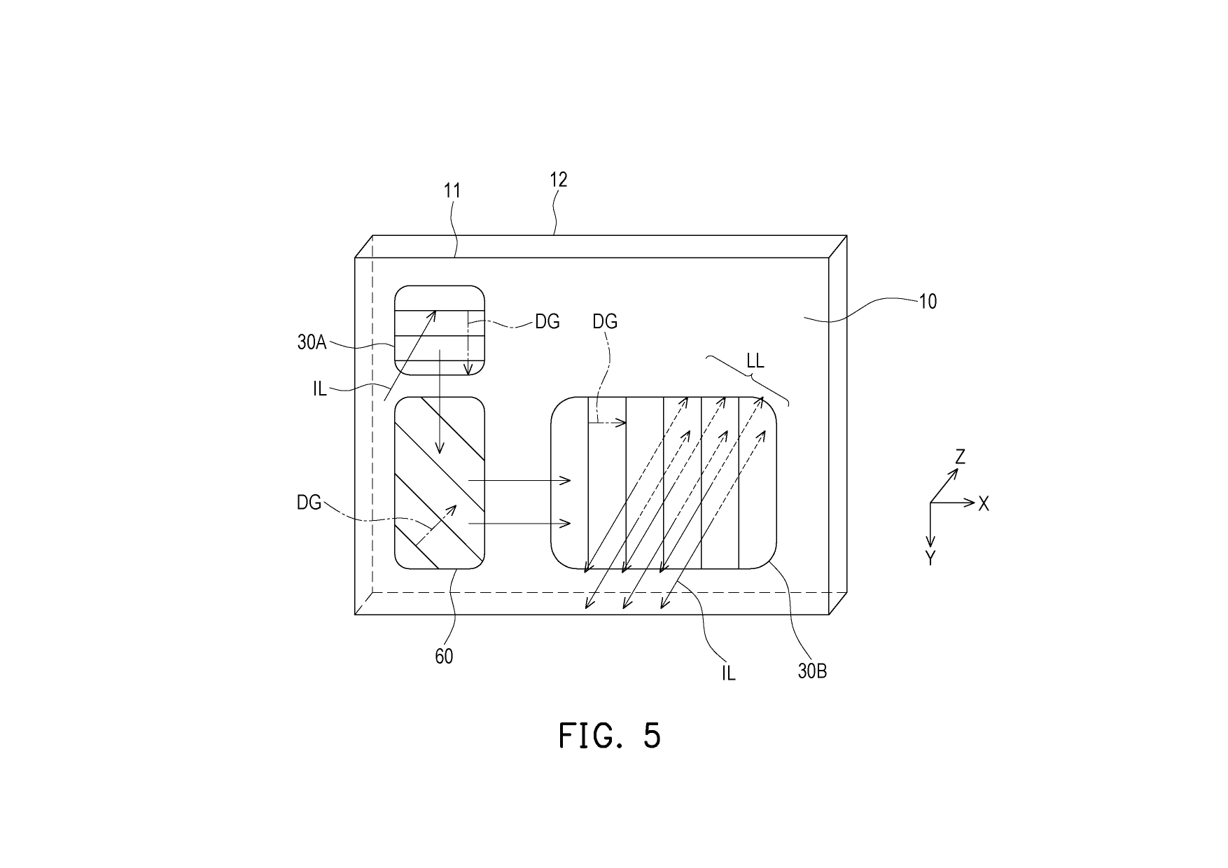

FIG. 5 is a partial schematic diagram of a near eye display device according to the fourth embodiment of the disclosure. Please refer to FIG. 5. In the foregoing embodiments, the near eye display device 1A, the near eye display device 1B, and the near eye display device 1C may also include a beam deflection element 60. The beam deflection element 60 is disposed on the first surface 11 and is adjacent to the light output coupling element 30B in the direction X and adjacent to the light input coupling element 30A in the negative direction Y. When the image beam IL is emitted from the image generating device 20 and is transmitted to the eye (as shown in FIG. 4), the image beam IL may sequentially propagate through the light input coupling element 30A, the beam deflection element 60, and the light output coupling element 30B.

The beam deflection element 60 may be a grating for implementing two-dimensional exit pupil expansion (2D EPE) and transmitting the image beam IL to the eye EYE of the user. Taking FIG. 5 as an example, a grating arrangement direction DG of the light input coupling element 30A may be parallel to the direction Y, a grating arrangement direction DG of the light output coupling element 30B may be parallel to the direction X, and a grating arrangement direction DG of the beam deflection element 60 may be neither parallel to the direction X nor parallel to the direction Y (for example, the grating arrangement direction DG of the beam deflection element 60 may be 45 degrees to the opposite directions of the direction X and the direction Y, but the disclosure is not limited thereto). The beam deflection element 60 may implement pupil expansion in the direction Y and may be configured to transmit the image beam IL from the light input coupling element 30A to the light output coupling element 30B, and the light output coupling element 30B may implement pupil expansion in the direction X and may be configured to transmit an image light from the beam deflection element 60 to the eye. It should be understood that in addition to adopting the structure exemplified in FIG. 5, other known gratings may also be adopted for the grating of any embodiment of the disclosure.

In summary, in the near eye display device of the disclosure, the light leakage suppression element and the light output coupling element are respectively disposed on the opposite sides of the waveguide. Via the action of the light leakage suppression element, the leakage light originally directed toward the front of the near eye display device may be transmitted toward other directions. Therefore, it is difficult for bystanders located in front of the near eye display device to observe a display image for the user, which facilitates enhancing the privacy of the user, and can also further optimize the appearance of the near eye display device to enhance product competitiveness.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A near eye display device, comprising:
a waveguide, having a first surface and a second surface opposite to each other, wherein the first surface comprises a light incident area and a light exit area;
an image generating device, adapted to emit an image beam toward the light incident area;
a light input coupling element, disposed in the light incident area;
a light output coupling element, disposed in the light exit area; and
a light leakage suppression element, disposed on the second surface and disposed opposite to the light exit area.

2. The near eye display device according to claim 1, further comprising a light guide layer disposed on a side of the light leakage suppression element away from the waveguide.

3. The near eye display device according to claim 1, wherein the light leakage suppression element is adapted to transmit a part of the image beam leaving the second surface toward a plane direction of the second surface.

4. The near eye display device according to claim 1, wherein the light leakage suppression element is at least one of a transmission grating and a reflection grating.

5. The near eye display device according to claim 1, further comprises a beam deflection element disposed on the first surface, wherein the image beam is transmitted out of the waveguide from the image generating device and sequentially propagates through the light input coupling element, the beam deflection element, and the light output coupling element.

6. The near eye display device according to claim 1, wherein an air layer or a refractive index matching medium is further comprised between the light leakage suppression element and the second surface.

7. The near eye display device according to claim 2, wherein a material of the light guide layer comprises glass.

8. The near eye display device according to claim 3, wherein the light incident area and the light exit area are arranged along a first direction, and the plane direction is substantially parallel to the first direction.

9. The near eye display device according to claim 3, wherein the light incident area and the light exit area are arranged along a first direction, and the plane direction is substantially perpendicular to the first direction.

10. The near eye display device according to claim 6, further comprising a spacer for maintaining a spacing between the light leakage suppression element and the second surface to form the air layer.
